(19) United States
(12) Patent Application Publication
(10) Pub. No.: US 2024/0284511 A1
(43) Pub. Date: Aug. 22, 2024

(54) MULTIPLE TRANSMISSIONS OF A PRACH

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Carmela Cozzo, San Diego, CA (US)

(21) Appl. No.: 18/430,426

(22) Filed: Feb. 1, 2024

Related U.S. Application Data
(60) Provisional application No. 63/446,294, filed on Feb. 16, 2023.

(51) Int. Cl. H04W 74/0833; H04L 1/08; H04W 74/00

(52) U.S. Cl. CPC H04W 74/0833; H04L 1/08; H04W 74/006

(57) ABSTRACT

Apparatuses and methods for multiple transmissions of a physical random access channel (PRACH). A method for includes identifying a set of numbers of repetitions for the PRACH preamble transmission and a first mapping among values of a PRACH mask index and a set of groups of PRACH occasions and receiving a downlink control information (DCI) format for a physical downlink control channel (PDCCH) order that indicates: a first value for a PRACH preamble index, a second value for a synchronization signal and physical broadcast channel (SS/PBCH) block index, and a third value for the PRACH mask index. The method further includes determining a number of repetitions from the set of numbers of repetitions and based on the third value and the first mapping, a group of PRACH occasions and transmitting the PRACH preamble with the number of repetitions over the group of PRACH occasions.

### CROSS-REFERENCE TO RELATED AND CLAIM OF PRIORITY

The present application claims priority under 35 U.S.C. § 119(e) to: U.S. Provisional Patent Application No. 63/446,294 filed on Feb. 16, 2023, which is hereby incorporated by reference in its entirety.

### TECHNICAL FIELD

The present disclosure relates generally to wireless communication systems and, more specifically, the present disclosure is related to apparatuses and methods for multiple transmissions of a physical random access channel (PRACH).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to multiple transmissions of a PRACH.

In one embodiment, a method for transmission of a PRACH preamble is provided. The method includes identifying a set of numbers of repetitions for the PRACH preamble transmission and a first mapping among values of a PRACH mask index and a set of groups of PRACH occasions and receiving a downlink control information (DCI) format for a physical downlink control channel (PDCCH) order that indicates: a first value for a PRACH preamble index, a second value for a synchronization signal and physical broadcast channel (SS/PBCH) block index, and a third value for the PRACH mask index. The method further includes determining a number of repetitions from the set of numbers of repetitions and, based on the third value and the first mapping, a group of PRACH occasions from the set of groups of PRACH occasions and transmitting the PRACH preamble having the PRACH preamble index with the number of repetitions over the group of PRACH occasions.

In another embodiment, a UE is provided. The UE includes a processor configured to identify a set of numbers of repetitions for a transmission of a PRACH preamble and a first mapping among values of a PRACH mask index and a set of groups of PRACH occasions. The UE further includes a transceiver operably coupled to the processor. The transceiver is configured to receive a DCI format for a PDCCH order that indicates: a first value for a PRACH preamble index, a second value for a SS/PBCH block index, and a third value for the PRACH mask index. The processor is further configured to determine a number of repetitions, from the set of numbers of repetitions, for the PRACH preamble transmission and, based on the third value and the first mapping, a group of PRACH occasions from the set of groups of PRACH occasions. The transceiver is further configured to transmit the PRACH preamble having the PRACH preamble index with the number of repetitions over the group of PRACH occasions.

In yet another embodiment, a base station is provided. The base station includes a processor configured to identify a set of numbers of repetitions for a reception of a PRACH preamble, and a first mapping among values of a PRACH mask index and a set of groups of PRACH occasions. The base station further includes a transceiver operably coupled to the processor. The transceiver is configured to transmit a DCI format for a PDCCH order that indicates: a first value for a PRACH preamble index, a second value for a SS/PBCH block index, and a third value for the PRACH mask index. The processor is further configured to determine a number of repetitions, from the set of numbers of repetitions, for the PRACH preamble reception, and, based on the third value and the first mapping, a group of PRACH occasions from the set of groups of PRACH occasions. The transceiver is further configured to receive the PRACH preamble having the PRACH preamble index with the number of repetitions over the group of PRACH occasions.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example UE procedure for transmitting a number of PRACH repetitions according to embodiments of the present disclosure;

FIG. 7 illustrates a flowchart of an example UE procedure for transmitting a number of PRACH repetitions according to embodiments of the present disclosure;

FIG. 8 illustrates a flowchart of an example UE procedure for transmitting a number of PRACH repetitions according to embodiments of the present disclosure;

FIG. 9 illustrates a flowchart of an example UE procedure for transmitting a number of PRACH repetitions according to embodiments of the present disclosure; and

FIG. 10 illustrates a flowchart of an example UE procedure for transmitting PRACH according to embodiments of the present disclosure.

### DETAILED DESCRIPTION

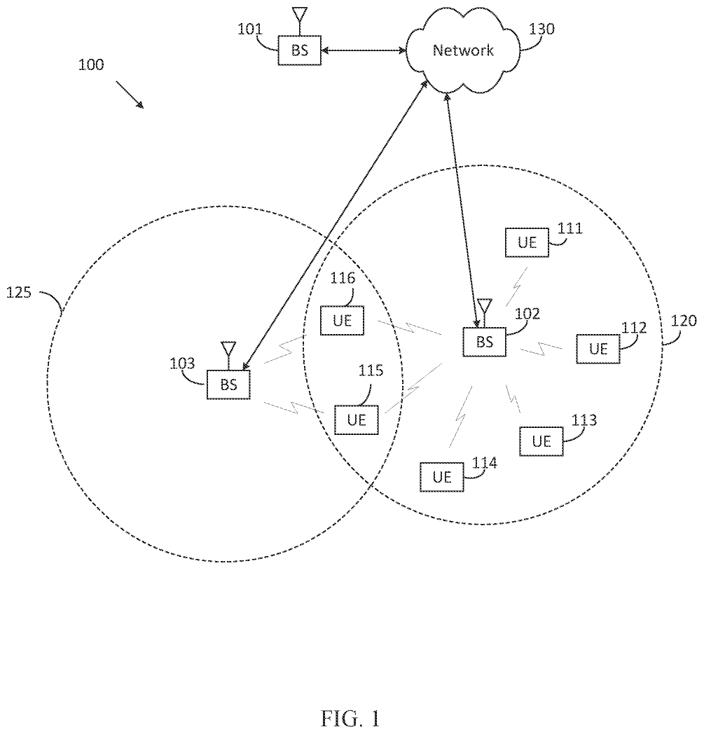

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and channel coding;” [3] 3GPP TS 38.213 v17.4.0, “NR; Physical layer procedures for control;” [4] 3GPP TS 38.214 v17.4.0, “NR; Physical layer procedures for data;” [5] 3GPP TS 38.215 v17.4.0, “NR; Physical layer measurements;” [6] 3GPP TS 38.321 v17.3.0, “NR; Medium Access Control (MAC) protocol specification;” [7] 3GPP TS 38.331 v17.2.0, “NR; Radio Resource Control (RRC) protocol specification;” and [8] 3GPP TS 38.300 v17.3.0, “NR; NR and NG-RAN Overall Description; Stage 2.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for multiple transmissions of a PRACH. In certain embodiments, one or more of the BSs 101-103 include circuitry, programing, or a combination thereof to for multiple receptions of a PRACH.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

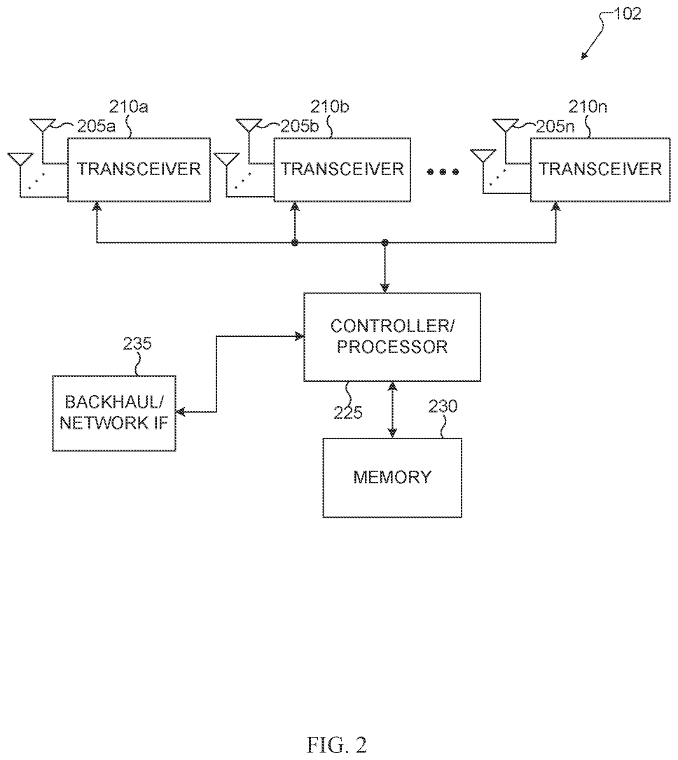

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for multiple receptions of a PRACH. Any of a wide variety of other functions could be supported in the gNB 102 by the controller/processor 225.

The controller/processor 225 is also capable of executing programs and other processes resident in the memory 230, such as processes for multiple receptions of a PRACH. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

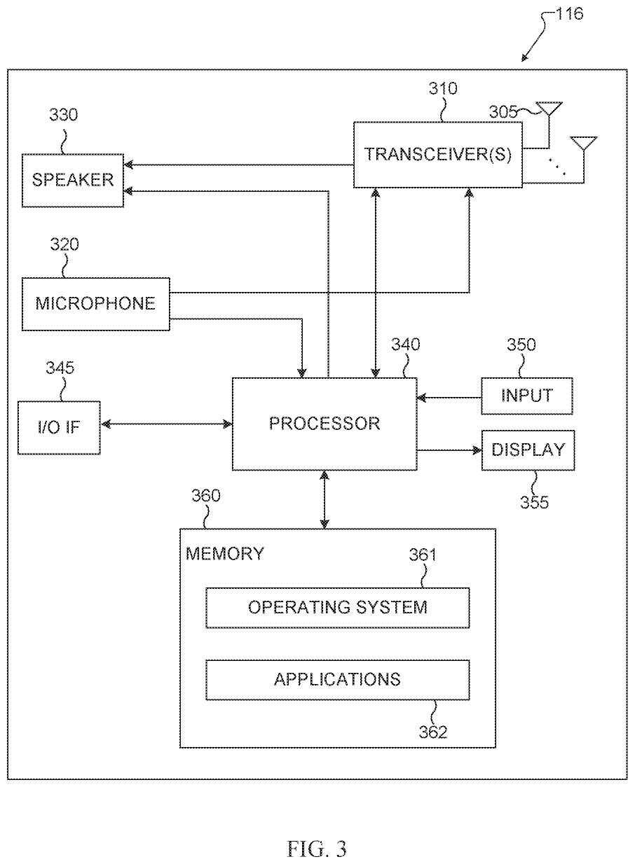

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing multiple transmissions of a PRACH as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

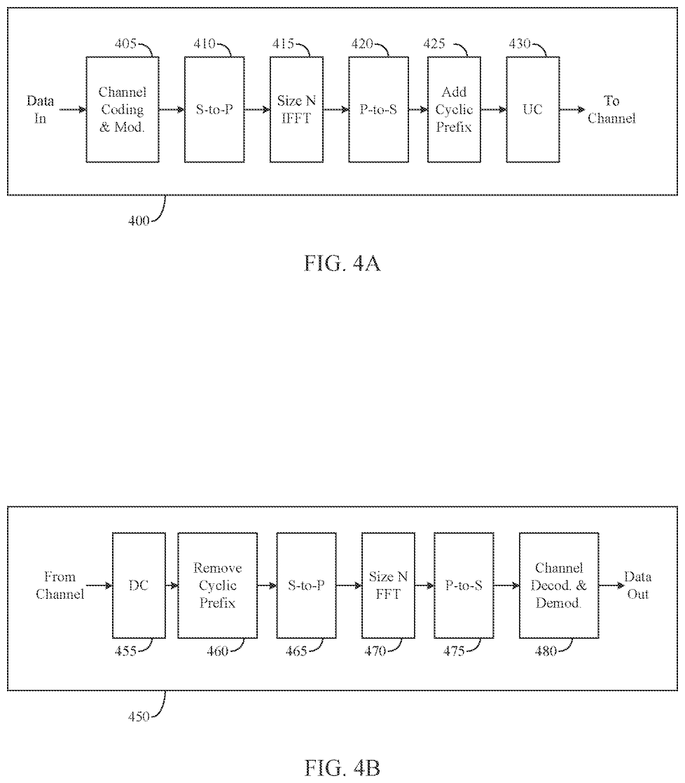

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to perform multiple transmissions of a PRACH as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or SRS. In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

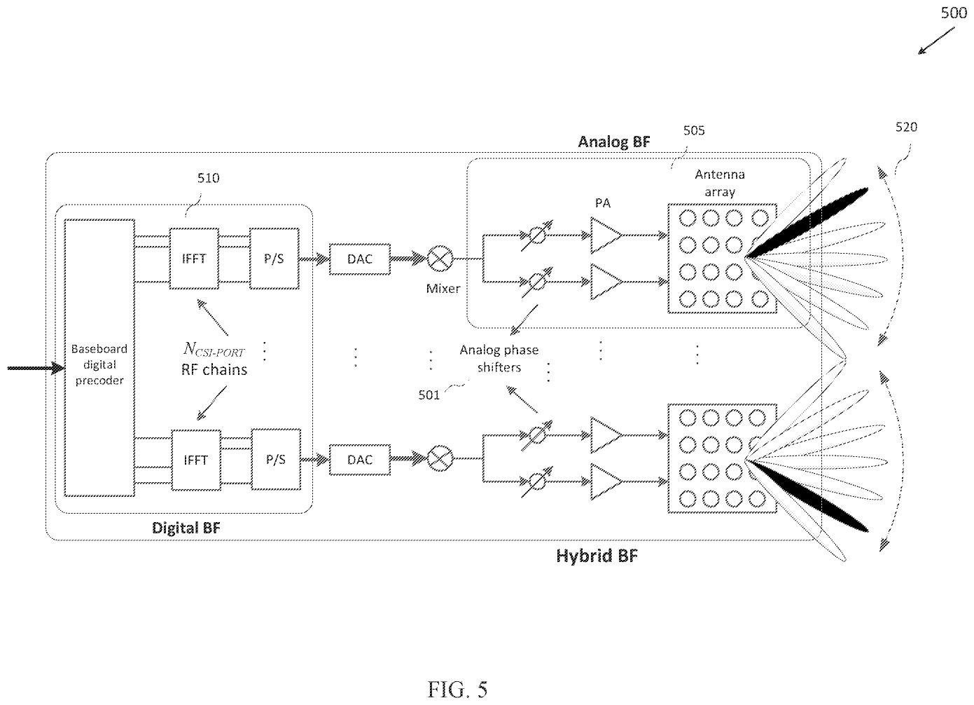

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

A description of example embodiments is provided on the following pages.

Throughout this disclosure, all FIGUREs such as FIG. 1, FIG. 2, and so on, illustrate examples according to embodiments of the present disclosure. For each FIGURE, the corresponding embodiment shown in the FIGURE is for illustration only. One or more of the components illustrated in each FIGURE can be implemented in specialized circuitry configured to perform the noted functions or one or more of the components can be implemented by one or more processors executing instructions to perform the noted functions. Other embodiments could be used without departing from the scope of the present disclosure. In addition, the descriptions of the FIGUREs are not meant to imply physical or architectural limitations to the manner in which different embodiments may be implemented. Different embodiments of the present disclosure may be implemented in any suitably-arranged communications system.

The present disclosure relates to a pre-5th-Generation (5G) or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

A UE can transmit a PRACH multiple times to improve coverage or reduce access latency. Multiple PRACH transmission can refer, for example, to multiple repetitions of a same PRACH preamble or to multiple transmissions of more than one PRACH preambles over a number of time/frequency resources (referred to as RACH occasions or ROs), for example, in a single random access (RA) attempt. For simplicity, throughput the disclosure, both cases for a same RA attempt (more than one transmission of a same PRACH preamble, or more than one transmission using different PRACH preambles) may be referred to as PRACH repetitions for a PRACH transmission or for a RA attempt.

The multiple PRACH transmissions can be by using a same spatial filter (UE Tx beam) or be associated with a same reference signal, such as a same SSB or CSI-RS, or can be by using different spatial filters (UE Tx beams) or associated with multiple different reference signals, such as multiple SSBs or CSI-RSs. A UE transmitter beam (UE Tx beam) refers to a spatial filter that a UE uses to transmit, for example, a signal or channel such as multiple PRACH transmissions (PRACH repetitions). A UE receiver beam (UE Rx beam) refers to a spatial filter that a UE uses to receive, for example, a RS such as an SSB or a CSI-RS, or a channel.

PRACH transmission can be triggered by higher layers at the UE or by network indication via a physical downlink control channel (PDCCH) order.

Therefore, embodiments of the present disclosure recognize there is a need to enable PDCCH order to trigger a PRACH transmission with repetitions.

The present disclosure provides methods and apparatus for PDCCH order for multiple PRACH transmissions/repetitions.

The embodiments apply to any deployments, verticals, or scenarios including PRACH transmissions in FR1 or FR2, for enhanced mobile broadband (eMBB), ultra reliable low latency communications (URLLC), industrial internet of things (IIoT), extended reality (XR), massive machine-type communications (mMTC) and internet of things (IoT) including LTE narrowband (NB)-IoT or NR IoT or Ambient IoT (A-IoT), with sidelink/V2X communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, and so on.

Embodiments of the disclosure are summarized in the following and are fully elaborated further herein. Combinations of the embodiments are also applicable, but they are not described in detail for brevity.
Mask index field in a PDCCH order for multiple PRACH repetitions: In one embodiment, for a PRACH transmission triggered by a PDCCH order, a UE can determine, based on DL RS measurements or based on gNB indication, to transmit the PRACH multiple times. A “mask index” field in a downlink control information (DCI) format, such as DCI format 1_0, for PDCCH order can be reinterpreted or new/additional “mask index” fields can be included in the PDCCH order to indicate information for an RO bundle that the UE uses for the multiple PRACH transmissions.
PRACH preamble index field in a PDCCH order for multiple PRACH repetitions: In one embodiment, for multiple PRACH transmissions triggered by a PDCCH order, a “PRACH preamble index” field in a DCI format, such as DCI format 1_0, for PDCCH order can indicate to a UE to use a same PRACH preamble for the multiple PRACH transmissions, or the “PRACH preamble index” field can be reinterpreted, or new/additional “PRACH preamble index” fields can be included in the PDCCH order to indicate information for a set/bundle of PRACH preambles for the UE to use for the multiple PRACH transmissions.
Beam/SSB cycling for multiple PRACH transmissions triggered/indicated by PDCCH order: In one embodiment, a PDCCH order can trigger/indicate multiple PRACH transmissions associated with two DL RSs, such as two SSBs. A field in the DCI format for PDCCH order can be re-interpreted/for indicating an SSB index or new fields can be included in the DCI format for PDCCH order to indicate information of two DL RSs, or information of a pattern for association of the two DL RSs with the multiple PRACH repetitions.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB 102 can configure the UE 116 to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE 116 to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE 116 may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channels (SS/PBCH) block transmitted within the same slot and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE 116 may not assume quasi co-location for any other synchronization signal SS/PBCH block transmissions.

In absence of CSI-RS configuration, and unless otherwise configured, the UE 116 may assume PDSCH DM-RS and SSB to be quasi co-located with respect to Doppler shift, Doppler spread, average delay, delay spread, and, when applicable, spatial Rx parameters. The UE 116 may assume that the PDSCH DM-RS within the same code division multiplexing (CDM) group is quasi co-located with respect to Doppler shift, Doppler spread, average delay, delay spread, and spatial Rx. The UE 116 may also assume that DM-RS ports associated with a PDSCH are QCL with QCL type A, type D (when applicable) and average gain. The UE 116 may further assume that no DM-RS collides with the SS/PBCH block.

The UE 116 can be configured with a list of up to M transmission configuration indication (TCI) State configurations within the higher layer parameter PDSCH-Config to decode PDSCH according to a detected PDCCH with DCI intended for the UE 116 and the given serving cell, where M depends on the UE 116 capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE 116 receives a medium access control (MAC)-control element (CE) activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}).

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by master information block (MIB) or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE 116 determines a common TDD UL-DL frame configuration of a serving cell by receiving a SIB such as a SIB1 when accessing the cell from RRC_IDLE or by RRC signaling when the UE 116 is configured with SCells or additional secondary cell groups (SCGs) by an IE ServingCellConfigCommon in RRC_CONNECTED. The UE 116 determines a dedicated TDD UL-DL frame configuration using the IE ServingCellConfig when the UE 116 is configured with a serving cell, e.g., add or modify, where the serving cell may be the SpCell or an SCell of a master cell group (MCG) or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE 116 by group common DCI format such as DCI F2_0 where slotFormats are defined in [REF3, TS 38.213].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network 130. During a half-frame, different SSBs may be transmitted in different spatial directions (i.e., using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with a remaining minimum system information (RMSI), the SSB is referred to as a Cell-Defining SSB (CD-SSB). A PCell is associated to a CD-SSB located on the synchronization raster.

Polar coding is used for PBCH. The UE 116 may assume a band-specific sub-carrier spacing for the SSB unless a network has configured the UE 116 to assume a different sub-carrier spacing. PBCH symbols carry its own frequency-multiplexed demodulation reference signal (DMRS). QPSK modulation is used for PBCH.

Measurement time resource(s) for SSB-based received signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Random access preamble sequences, of four different lengths are supported. Sequence length 839 is applied with subcarrier spacings of 1.25 and 5 kHz, sequence length 139 is applied with subcarrier spacings of 15, 30, 60, 120, 480, and 960 kHz. Sequence length of 571 is applied with subcarrier spacings of 30, 120, and 480 kHz. Sequence length 1151 is applied with subcarrier spacings of 15 and 120 kHz. Sequence length 839 supports unrestricted sets and restricted sets of Type A and Type B, while sequence lengths 139, 571, and 1151 support unrestricted sets only. Sequence length 839 is only used for operation with licensed channel access while sequence length 139 can be used for operation with either licensed or shared spectrum channel access. For FR1, sequence lengths of 571 and 1151 can be used only for operation with shared spectrum channel access. For FR2-2, sequence lengths of 571 and 1151 can be used for operation with either licensed or shared spectrum channel access.

Multiple PRACH preamble formats are defined with one or more PRACH OFDM symbols, and different CP and guard time. The PRACH preamble configuration to use is provided to the UE 116 in the system information.

For integrated access and backhaul (IAB) additional random access configurations are defined. These configurations are obtained by extending the random access configurations defined for UEs via scaling the periodicity and/or offsetting the time domain position of the RACH occasions.

IAB-mobile terminals (MTs) can be provided with random access configurations (as defined for UEs or after applying the aforementioned scaling/offsetting) different from random access configurations provided to UEs.

The UE 116 calculates the PRACH transmit power for the retransmission of the preamble based on the most recent estimate pathloss and power ramping counter.

The system information provides information for the UE 116 to determine the association between the SSB and the RACH resources. The RSRP threshold for SSB selection for RACH resource association is configurable by network.

During the random access procedure, the following identities are also used:
random access (RA)-radio network temporary identifier (RNTI): identification of the Random Access Response in the downlink;
Temporary C-RNTI: UE identification temporarily used for scheduling during the random access procedure; and/or
Random value for contention resolution: UE identification temporarily used for contention resolution purposes during the random access procedure.

The random access procedure is triggered by a number of events:
Initial access from RRC_IDLE;
RRC Connection Re-establishment procedure;
DL or UL data arrival, during RRC_CONNECTED or during RRC_INACTIVE while small data transmission (SDT) procedure (see clause 18.0) is ongoing, when UL synchronisation status is “non-synchronised”;
UL data arrival, during RRC_CONNECTED or during RRC_INACTIVE while SDT procedure is ongoing, when there are no PUCCH resources for SR available;
SR failure;
Request by RRC upon synchronous reconfiguration (e.g., handover);
RRC Connection Resume procedure from RRC_INACTIVE;
To establish time alignment for a secondary TAG;
Request for Other SI;
Beam failure recovery;
Consistent UL listen-before-talk (LBT) failure on SpCell;
SDT in RRC_INACTIVE; and/or
Positioning purpose during RRC_CONNECTED requiring random access procedure, e.g., when timing advance is needed for UE positioning.

Two types of random access procedure are supported: 4-step RA type with message (MSG)1 and 2-step RA type with MSGA. Both types of RA procedure support contention-based random access (CBRA) and contention-free random access (CFRA).

The UE 116 selects the type of random access at initiation of the random access procedure based on network configuration:
when CFRA resources are not configured, an RSRP threshold is used by the UE 116 to select between 2-step RA type and 4-step RA type;
when CFRA resources for 4-step RA type are configured, UE performs random access with 4-step RA type;
when CFRA resources for 2-step RA type are configured, UE performs random access with 2-step RA type.

The network 130 does not configure CFRA resources for 4-step and 2-step RA types at the same time for a Bandwidth Part (BWP). CFRA with 2-step RA type is only supported for handover.

The MSG1 of the 4-step RA type includes a preamble on PRACH. After MSG1 transmission, the UE 116 monitors for a response from the network 130 within a configured window. For CFRA, dedicated preamble for MSG1 transmission is assigned by the network 130 and upon receiving random access response from the network 130, the UE 116 ends the random access procedure. For CBRA, upon reception of the random access response, the UE 116 sends MSG3 using the UL grant scheduled in the response and monitors contention resolution. If contention resolution is not successful after MSG3 (re)transmission(s), the UE 116 goes back to MSG1 transmission.

The MSGA of the 2-step RA type includes a preamble on PRACH and a payload on PUSCH. After MSGA transmission, the UE 116 monitors for a response from the network 130 within a configured window. For CFRA, dedicated preamble and PUSCH resource are configured for MSGA transmission and, upon receiving the network 130 response, the UE 116 ends the random access procedure. For CBRA, if contention resolution is successful upon receiving the network 130 response, the UE 116 ends the random access procedure; while, if fallback indication is received in MSGB, the UE 116 performs MSG3 transmission using the UL grant scheduled in the fallback indication and monitors contention resolution. If contention resolution is not successful after MSG3 (re)transmission(s), the UE 116 goes back to MSGA transmission.

If the random access procedure with 2-step RA type is not completed after a number of MSGA transmissions, the UE 116 can be configured to switch to CBRA with 4-step RA type.

For random access in a cell configured with supplementary uplink (SUL), the network 130 can explicitly signal which carrier to use (UL or SUL). Otherwise, the UE 116 selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network 130 can associate a set of RACH resources with feature(s) applicable to a Random Access procedure: Network Slicing, RedCap, SDT, and NR coverage enhancement. A set of RACH resources associated with a feature is only valid for random access procedures applicable to at least that feature; and a set of RACH resources associated with several features is only valid for random access procedures having at least all of these features. The UE 116 selects the set(s) of applicable RACH resources, after uplink carrier (i.e., normal uplink (NUL) or SUL) and BWP selection and before selecting the RA type.

When CA is configured, random access procedure with 2-step RA type is only performed on PCell while contention resolution can be cross-scheduled by the PCell.

When CA is configured, for random access procedure with 4-step RA type, the first three steps of CBRA occur on the PCell while contention resolution (step 4) can be cross-scheduled by the PCell. The three steps of a CFRA started on the PCell remain on the PCell. CFRA on SCell can only be initiated by the gNB 102 to establish timing advance for a secondary TAG: the procedure is initiated by the gNB 102 with a PDCCH order (step 0) that is sent on a scheduling cell of an activated SCell of the secondary TAG, preamble transmission (step 1) takes place on the indicated SCell, and Random Access Response (step 2) takes place on PCell.

To improve NR uplink coverage for both FR1 and FR2, aggregation of multiple slots with TB repetition for MSG3 transmission is supported on both NUL and SUL, applicable to CBRA with 4-step RA type. If configured, the UE 116 requests MSG3 repetition via separate RACH resources when the RSRP of a DL reference signal is lower than a configured threshold. A BWP configured with RACH resources solely for repetitions of an MSG3 transmission is also supported without the need to evaluate the RSRP of the DL reference signal by the UE 116.

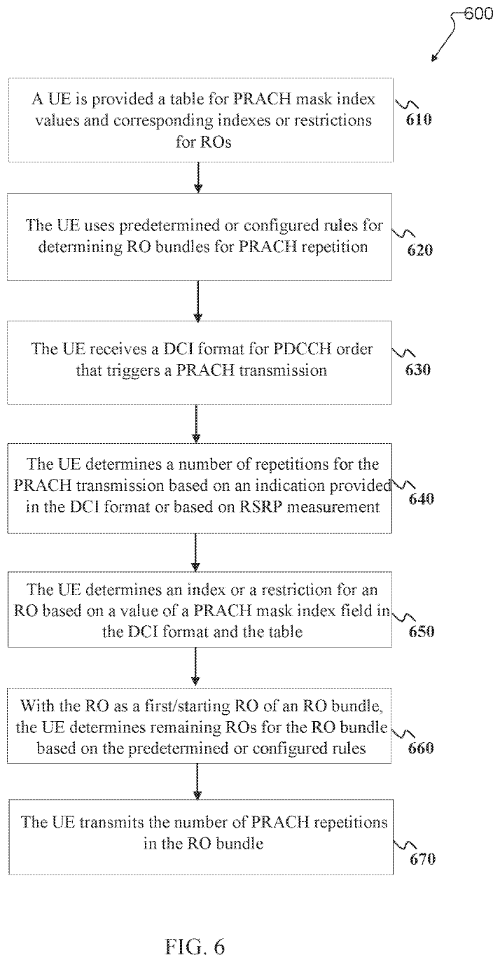

FIG. 6 illustrates a flowchart of an example UE procedure 600 for transmitting a number of PRACH repetitions according to embodiments of the present disclosure. For example, UE procedure 600 for transmitting a number of PRACH repetitions can be performed by any of the UEs 111-116 of FIG. 1. This example is for illustration only and other embodiments can be used without departing from the scope of the present disclosure.

The procedure begins in 610, a UE is provided a table for PRACH mask index values and corresponding indexes or restrictions for ROs. In 620, the UE 116 uses predetermined or configured rules for determining RO bundles for PRACH repetition. In 630, the UE 116 receives a DCI format for PDCCH order that triggers a PRACH transmission. In 640, the UE 116 determines a number of repetitions for a PRACH transmission based on an indication provided in the DCI format or based on RSRP measurement. In 650, the UE 116 determines an index or a restriction for an RO based on a value of a PRACH mask index field in the DCI format and the table. In 660, with the RO as a first/starting RO of an RO bundle, the UE 116 determines remaining ROs for the RO bundle based on the predetermined or configured rules. In 670, the UE 116 transmits the number of PRACH repetitions in the RO bundle.

If the cyclic redundancy check (CRC) of the DCI format 1_0 is scrambled by C-RNTI and the “Frequency domain resource assignment” field are of all ones, the DCI format 1_0 is for random access procedure initiated by a PDCCH order, with all remaining fields set as follows:
Random Access Preamble index—6 bits according to ra-PreambleIndex in Clause 5.1.2 of [REF6, TS 38.321];
UL/SUL indicator—1 bit. If the value of the “Random Access Preamble index” is not all zeros and if the UE 116 is configured with supplementaryUplink in ServingCellConfig in the cell, this field indicates which UL carrier in the cell to transmit the PRACH; otherwise, this field is reserved;
SS/PBCH index—6 bits. If the value of the “Random Access Preamble index” is not all zeros, this field indicates the SS/PBCH that shall be used to determine the RACH occasion for the PRACH transmission; otherwise, this field is reserved;
PRACH Mask index—4 bits. If the value of the “Random Access Preamble index” is not all zeros, this field indicates the RACH occasion associated with the SS/PBCH indicated by “SS/PBCH index” for the PRACH transmission, according to Clause 5.1.1 of [REF6, TS 38.321]; otherwise, this field is reserved; and/or
Reserved bits—12 bits for operation in a cell with shared spectrum channel access in frequency range 1 or when the DCI format is monitored in common search space for operation in a cell in frequency range 2-2; otherwise, 10 bits.

TABLE 0
PRACH Mask Index values

| PRACH Mask Index | |
|---|---|
| msgA-SSB-SharedRO-MaskIndex | Allowed PRACH occasion(s) of SSB |
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | Reserved |
| 12 | Reserved |
| 13 | Reserved |
| 14 | Reserved |
| 15 | Reserved |

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure or a Type-2 random access procedure.

Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant and PDSCH for contention resolution.

If a random access procedure is initiated by a PDCCH order to the UE 116, a PRACH transmission is with a same subcarrier spacing (SCS) as a PRACH transmission initiated by higher layers.

If a UE is configured with two UL carriers for a serving cell and the UE 116 detects a PDCCH order, the UE 116 uses the UL/SUL indicator field value from the detected PDCCH order to determine the UL carrier for the corresponding PRACH transmission.

Physical random access procedure is triggered upon request of a PRACH transmission by higher layers or by a PDCCH order. A configuration by higher layers for a PRACH transmission includes the following:
A configuration for PRACH transmission [REF1, TS 38.211].
A preamble index, a preamble SCS, P_{PRACH,target}, a corresponding RA-RNTI, and a PRACH resource.

A PRACH is transmitted using the selected PRACH format with transmission power P_{PRACH,b,ƒ,c}(i), on the indicated PRACH resource.

For Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For Type-2 random access procedure with common configuration of PRACH occasions with Type-1 random access procedure, a UE is provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB-PerSharedRO. The PRACH transmission can be on a subset of PRACH occasions associated with a same SS/PBCH block index within an SSB-RO mapping cycle for a UE provided with a PRACH mask index by msgA-SSB-SharedRO-MaskIndex according to [REF6, TS 38.321].

For Type-2 random access procedure with separate configuration of PRACH occasions with Type-1 random access procedure, a UE is provided a number N of SS/PBCH block indexes associated with one PRACH occasion and a number R of contention based preambles per SS/PBCH block index per valid PRACH occasion by msgA-SSB-PerRACH-OccasionAndCB-PreamblesPerSSB when provided; otherwise, by ssb-perRACH-OccasionAndCB-PreamblesPerSSB.

For a random access procedure associated with a feature combination indicated by FeatureCombinationPreambles, a UE is provided a number N of SS/PBCH block indexes associated with one PRACH occasion by ssb-perRACH-OccasionAndCB-PreamblesPerSSB or msgA-SSB-PerRACH-OccasionAndCB-PreamblesPerSSB when provided and a number S of contention based preambles per SS/PBCH block index per valid PRACH occasion by startPreambleForThisPartition and memberOfPreamblesPerSSB-ForThisPartition. The PRACH transmission can be on a subset of PRACH occasions associated with a same SS/PBCH block index within an SSB-RO mapping cycle for a UE provided with a PRACH mask index by ssb-SharedRO-MaskIndex according to [REF6, TS 38.321].

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·N_{preamble}^{total}/N where N_{preamble}^{total} is provided by totalNumberOfRA-Preambles for Type-1 random access procedure, or by msgA-TotalNumberOfRA-Preambles for Type-2 random access procedure with separate configuration of PRACH occasions from a Type 1 random access procedure and is an integer multiple of N.

For Type-2 random access procedure with common configuration of PRACH occasions with Type-1 random access procedure, if N<1, one SS/PBCH block index is mapped to 1/N consecutive valid PRACH occasions and Q contention based preambles with consecutive indexes associated with the SS/PBCH block index per valid PRACH occasion start from preamble index R. If N≥1, Q contention based preambles with consecutive indexes associated with SS/PBCH block index n, 0≤n≤N−1, per valid PRACH occasion start from preamble index n·N_{preamble}^{total}/N+R, where N_{preamble}^{total} is provided by totalNumberOfRA-Preambles for Type-1 random access procedure.

For link recovery, a UE is provided N SS/PBCH block indexes associated with one PRACH occasion by ssb-perRACH-Occasion in BeamFailureRecoveryConfig. For a dedicated RACH configuration provided by RACH-ConfigDedicated, if cfra is provided, a UE is provided N SS/PBCH block indexes associated with one PRACH occasion by ssb-perRACH-Occasion in occasions. If N<1, one SS/PBCH block index is mapped to 1/N consecutive valid PRACH occasions. If N≥1, all consecutive N SS/PBCH block indexes are associated with one PRACH occasion.

SS/PBCH block indexes provided by ssb-PositionsInBurst in SIB1 or in ServingCellConfigCommon are mapped to valid PRACH occasions in the following order where the parameters are described in [REF1, TS 38.211].
First, in increasing order of preamble indexes within a single PRACH occasion;
Second, in increasing order of frequency resource indexes for frequency multiplexed PRACH occasions;
Third, in increasing order of time resource indexes for time multiplexed PRACH occasions within a PRACH slot; and/or
Fourth, in increasing order of indexes for PRACH slots.

An association period, starting from frame 0, for mapping SS/PBCH block indexes to PRACH occasions is the smallest value in the set determined by the PRACH configuration period according Table 1 such that N_{Tx}^{SSB} SS/PBCH block indexes are mapped at least once to the PRACH occasions within the association period, where a UE obtains N_{Tx}^{SSB} from the value of ssb-PositionsInBurst in SIB1 or in ServingCellConfigCommon. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

For a PRACH transmission by a UE triggered by a PDCCH order, the PRACH mask index field [REF2, TS 38.212], if the value of the random access preamble index field is not zero, indicates the PRACH occasion for the PRACH transmission where the PRACH occasions are associated with the SS/PBCH block index indicated by the SS/PBCH block index field of the PDCCH order. If the UE 116 is provided K_{cell,offset} by cellSpecificKoffset, the PRACH occasion is after slot n+2^{μ}·K_{cell,offset} where n is the slot of the UL BWP for the PRACH transmission that overlaps with the end of the PDCCH order reception assuming T_{TA}=0, and μ is the SCS configuration for the PRACH transmission. If the PDCCH reception for the PDCCH order includes two PDCCH candidates from two linked search space sets based on searchSpaceLinkingId, as described in clause 10.1, the last symbol of the PDCCH reception is the last symbol of the PDCCH candidate that ends later. The PDCCH reception includes the two PDCCH candidates also when the UE 116 is not required to monitor one of the two PDCCH candidates.

For a PRACH transmission triggered by higher layers, if ssb-ResourceList is provided, the PRACH mask index is indicated by ra-ssb-OccasionMaskIndex which indicates the PRACH occasions for the PRACH transmission where the PRACH occasions are associated with the selected SS/PBCH block index.

The PRACH occasions are mapped consecutively per corresponding SS/PBCH block index. The indexing of the PRACH occasion indicated by the mask index value is reset per mapping cycle of consecutive PRACH occasions per SS/PBCH block index. The UE 116 selects for a PRACH transmission the PRACH occasion indicated by PRACH mask index value for the indicated SS/PBCH block index in the first available mapping cycle.

For the indicated preamble index, the ordering of the PRACH occasions is:
First, in increasing order of frequency resource indexes for frequency multiplexed PRACH occasions;
Second, in increasing order of time resource indexes for time multiplexed PRACH occasions within a PRACH slot; and/or
Third, in increasing order of indexes for PRACH slots.

For a PRACH transmission triggered upon request by higher layers, a value of ra-OccasionList [REF7, TS 38.331], if csirs-ResourceList is provided, indicates a list of PRACH occasions for the PRACH transmission where the PRACH occasions are associated with the selected CSI-RS index indicated by csi-RS. The indexing of the PRACH occasions indicated by ra-OccasionList is reset per association pattern period.

TABLE 1
Mapping between PRACH configuration period and SS/PBCH
block to PRACH occasion association period

| PRACH configuration period | Association period (number of |
|---|---|
| (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

For paired spectrum or supplementary uplink band, all PRACH occasions are valid.

For unpaired spectrum:
if a UE is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided in Table 8.1-2 of [REF3, TS 38.213 v17.4.0]. If channelAccessMode=“semiStatic” is provided, does not overlap with a set of consecutive symbols before the start of a next channel occupancy time where the UE 116 does not transmit:
   the candidate SS/PBCH block index of the SS/PBCH block corresponds to the SS/PBCH block index provided by ssb-PositionsInBurst in SIB1 or in ServingCellConfigCommon:
If a UE is provided tdd-UL-DL-ConfigurationCommon, a PRACH occasion in a PRACH slot is valid if:
   it is within UL symbols; or
   it does not precede a SS/PBCH block in the PRACH slot and starts at least N_{gap} symbols after a last downlink symbol and at least N_{gap} symbols after a last SS/PBCH block symbol, where N_{gap} is provided in Table 2, and if channelAccessMode=“semiStatic” is provided, does not overlap with a set of consecutive symbols before the start of a next channel occupancy time where there shall not be any transmissions:
      the candidate SS/PBCH block index of the SS/PBCH block corresponds to the SS/PBCH block index provided by ssb-PositionsInBurst in SIB1 or in ServingCellConfigCommon, as described in clause 4.1.

For preamble format B4 [REF1, TS 38.211], N_{gap}=0.

TABLE 2
N_{gap} values for different preamble SCS μ

| Preamble SCS | N_{gap} |
|---|---|
| 1.25 kHz or 5 kHz | 0 |
| 15 kHz or 30 kHz or 60 kHz or 120 kHz | 2 |
| 480 kHz | 8 |
| 960 kHz | 16 |

If a random access procedure is initiated by a PDCCH order, the UE 116, if requested by higher layers, transmits a PRACH in the selected PRACH occasion, as described in [REF6, TS 38.321], for which a time between the last symbol of the PDCCH order reception and the first symbol of the PRACH transmission is larger than or equal to N_{T,2}+Δ_{BWPSwitching}+Δ_{Delay}++T_{switch} msec, where:
N_{T,2} is a time duration of N₂ symbols corresponding to a PUSCH preparation time for UE processing capability 1 [REF4, TS 38.214] assuming μ corresponds to the smallest SCS configuration between the SCS configuration of the PDCCH order and the SCS configuration of the corresponding PRACH transmission;
Δ_{BWPSwitching}=0 if the active UL BWP does not change and Δ_{BWPSwitching} is defined in [TS 38.133] otherwise;
Δ_{Delay}=0.5 msec for FR1 and Δ_{Delay}=0.25 msec for FR2; and/or
T_{switch} is a switching gap duration as defined in [REF4, TS 38.214].

For a PRACH transmission using 1.25 kHz or 5 kHz SCS, the UE 116 determines N₂ assuming SCS configuration μ=0.

For single cell operation or for operation with contiguous carrier aggregation in a same frequency band or for operation with non-contiguous carrier aggregation in a same frequency band if the UE 116 is not provided with intraBandNC-PRACH-simulTx-r17, a UE does not transmit PRACH and PUSCH/PUCCH/SRS in a same slot with respect to the smallest SCS configuration between the SCS configuration for the UL BWP with the PRACH and the SCS configuration for the UL BWP with the PUSCH/PUCCH/SRS transmissions or when a gap between the first or last symbol of a PRACH transmission in a first slot is separated by less than N symbols from the last or first symbol, respectively, of a PUSCH/PUCCH/SRS transmission in a second slot where N=2 for μ=0 or μ=1, N=4 for μ=2 or μ=3, N=16 for μ=5, N=32 for μ=6, and μ is the smallest SCS configuration between the SCS configuration for the UL BWP with the PRACH and the SCS configuration for the UL BWP with the PUSCH/PUCCH/SRS transmissions. For a PUSCH transmission with repetition Type B, this applies to each actual repetition for PUSCH transmission [REF4, TS 38.214].

In response to a PRACH transmission, a UE attempts to detect a DCI format 1_0 with CRC scrambled by a corresponding RA-RNTI during a window controlled by higher layers [REF6, TS 38.321]. The window starts at the first symbol of the earliest CORESET the UE 116 is configured to receive PDCCH for Type1-PDCCH common search space (CSS) set, as defined in clause 10.1, that is at least one symbol after the last symbol of the PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [REF1, TS 38.211], is not zero, the window starts after an additional T_{TA}+k_{mac} msec where T_{TA} is defined in [REF1, TS 38.211] and k_{mac} is provided by kmac or k_{mac}=0 if kmac is not provided. The length of the window in number of slots, based on the SCS for Type1-PDCCH CSS set, is provided by ra-ResponseWindow.

If the UE 116 detects the DCI format 1_0 with CRC scrambled by the corresponding RA-RNTI and LSBs of a single frequency network (SFN) field in the DCI format 1_0, if included and applicable, are same as corresponding LSBs of the SFN where the UE 116 transmitted PRACH, and the UE 116 receives a transport block in a corresponding PDSCH within the window, the UE 116 passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

If the UE 116 does not detect the DCI format 1_0 with CRC scrambled by the corresponding RA-RNTI within the window, or if the UE 116 detects the DCI format 1_0 with CRC scrambled by the corresponding RA-RNTI within the window and LSBs of a SFN field in the DCI format 1_0, if included and applicable, are not same as corresponding LSBs of the SFN where the UE 116 transmitted PRACH, or if the UE 116 does not correctly receive the transport block in the corresponding PDSCH within the window, or if the higher layers do not identify the RAPID associated with the PRACH transmission from the UE 116, the higher layers can indicate to the physical layer to transmit a PRACH. If requested by higher layers, the UE 116 shall be ready to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE 116 assumes N_{1,0}=14 [REF4, TS 38.214]. For a PRACH transmission using 1.25 kHz or 5 kHz SCS, the UE 116 determines N₁ assuming SCS configuration μ=0.

If the UE 116 detects a DCI format 1_0 with CRC scrambled by the corresponding RA-RNTI and LSBs of a SFN field in the DCI format 1_0, if included and applicable, are same as corresponding LSBs of the SFN where the UE 116 transmitted the PRACH, and the UE 116 receives a transport block in a corresponding PDSCH, the UE 116 may assume same DM-RS antenna port quasi co-location properties, as described in [REF4, TS 38.214], as for a SS/PBCH block or a CSI-RS resource the UE 116 used for PRACH association, as described in clause 8.1, regardless of whether or not the UE 116 is provided TCI-State for the CORESET where the UE 116 receives the PDCCH with the DCI format 1_0.

If the UE 116 attempts to detect the DCI format 1_0 with CRC scrambled by the corresponding RA-RNTI in response to a PRACH transmission initiated by a PDCCH order that triggers a contention-free random access procedure for the SpCell [REF6, TS 38.321], the UE 116 may assume that the PDCCH that includes the DCI format 1_0 and the PDCCH order have same DM-RS antenna port quasi co-location properties. If the UE 116 attempts to detect the DCI format 1_0 with CRC scrambled by the corresponding RA-RNTI in response to a PRACH transmission initiated by a PDCCH order that triggers a contention-free random access procedure for a secondary cell, the UE 116 may assume the DM-RS antenna port quasi co-location properties of the CORESET associated with the Type1-PDCCH CSS set for receiving the PDCCH that includes the DCI format 1_0.

A RAR UL grant schedules a PUSCH transmission from the UE 116. The contents of the RAR UL grant, starting with the most significant bit (MSB) and ending with the LSB, are given in Table 3.

If the value of the frequency hopping flag is 0, the UE 116 transmits the PUSCH without frequency hopping; otherwise, the UE 116 transmits the PUSCH with frequency hopping.

The UE 116 determines the MCS of the PUSCH transmission from the first sixteen indexes of the applicable MCS index table for PUSCH as described in [REF4, TS 38.214].

The transmit power control (TPC) command value δ_{msg2,b,ƒ,c} is used for setting the power of the PUSCH transmission and is interpreted according to Table 2.

The CSI request field is reserved.

The ChannelAccess-CPext field indicates a channel access type and CP extension for operation with shared spectrum channel access.

TABLE 3
Random Access Response Grant Content field size

| RAR grant field | Number of bits |
|---|---|
| Frequency hopping flag | 1 |
| PUSCH frequency resource | 12, for operation with shared spectrum |
| allocation | channel access in FR1 or for FR2-2 when |
| | ChannelAccessMode2-r17 is provided |
| | 14, otherwise |
| PUSCH time resource | 4 |
| allocation | |
| MCS | 4 |
| TPC command for PUSCH | 3 |
| CSI request | 1 |
| ChannelAccess-CPext | 2, for operation with shared spectrum |
| | channel access in FR1 or for FR2-2 when |
| | ChannelAccessMode2-r17 is provided |
| | 0, otherwise |

TABLE 4
TPC Command δ_{msg2, b, f, c} for PUSCH

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

Unless the UE 116 is configured a SCS, the UE 116 receives subsequent PDSCH using same SCS as for the PDSCH reception providing the RAR message.

If the UE 116 does not detect the DCI format 1_0 with CRC scrambled by the corresponding RA-RNTI within the window, or if the UE 116 detects the DCI format 1_0 with CRC scrambled by the corresponding RA-RNTI within the window and the LSBs of a SFN field in the DCI format 1_0, if included and applicable, are not same as corresponding LSBs of the SFN where the UE 116 transmitted the PRACH, or the UE 116 does not correctly receive a corresponding transport block within the window, the UE 116 procedure is as described in [REF6, TS 38.321].

An active UL BWP with SCS configuration u for a PUSCH transmission scheduled by a RAR UL grant is indicated by higher layers.

If useInterlacePUCCH-PUSCH is not provided by BWP-UplinkCommon and BWP-UplinkDedicated, for determining the frequency domain resource allocation for the PUSCH transmission within the active UL BWP:
if the active UL BWP and the initial UL BWP have same SCS and same CP length and the active UL BWP includes all RBs of the initial UL BWP, or the active UL BWP is the initial UL BWP, the initial UL BWP is used.
else, the RB numbering starts from the first RB of the active UL BWP and the maximum number of RBs for frequency domain resource allocation equals the number of RBs in the initial UL BWP.

The frequency domain resource allocation is by uplink resource allocation type 1 [REF4, TS 38.214]. For an initial UL BWP size of N_{BWP}^{size} RBs, a UE processes the frequency domain resource assignment field as follows:
if N_{BWP}^{size}≤180, or for operation with shared spectrum channel access in FR1 or for FR2-2 when ChannelAccessMode2-r17 is provided if N_{BWP}^{size}≤90:
   truncate the frequency domain resource assignment field to its ┌log₂(N_{BWP}^{size}·(N_{BWP}^{size}+1)/2)┐ least significant bits and interpret the truncated frequency resource assignment field as for the frequency resource assignment field in DCI format 0_0 as described in [5, TS 38.212].
else,
   insert:
      ┌log₂(N_{BWP}^{size}·(N_{BWP}^{size}+1)/2)┐−12 most significant bits, for operation with shared spectrum channel access in FR1 or for FR2-2 when ChannelAccessMode2-r17 is provided;
      ┌log₂(N_{BWP}^{size}·(N_{BWP}^{size}+1)/2)┐−14 most significant bits, otherwise;
         with value set to ‘0’ after the N_{UL,hop} bits to the frequency domain resource assignment field, where N_{UL,hop}=0 if the frequency hopping flag is set to ‘0’ and N_{UL,hop} is provided in Table 5 if the hopping flag bit is set to ‘1’, and interpret the expanded frequency resource assignment field as for the frequency resource assignment field in DCI format 0_0 as described in [REF2, TS 38.212]
end if:
If useInterlacePUCCH-PUSCH is provided by BWP-UplinkCommon or BWP-UplinkDedicated, the frequency domain resource allocation is by uplink resource allocation type 2 [REF4, TS 38.214]. A UE processes the frequency domain resource assignment field as follows:
   truncate the frequency domain resource assignment field to the X=6 LSBs if μ=0, or to the X=5 LSBs if μ=1;
   for interlace allocation of a PUSCH transmission, interpret the X MSBs of the truncated frequency domain resource assignment field for the active UL BWP as for the X MSBs of the frequency domain resource assignment field in DCI format 0_0 [REF4, TS 38.214]; and/or
   for RB set allocation of a PUSCH transmission, the RB set of the active UL BWP is the RB set of the PRACH transmission associated with the RAR UL grant. The UE 116 assumes that the RB set is defined as when the UE 116 is not provided intraCellGuardBandsUL-List [REF4, TS 38.214].

A UE determines whether or not to apply transform precoding as described in [REF4, TS 38.214].

For a PUSCH transmission with frequency hopping scheduled by RAR UL grant or for a Msg3 PUSCH retransmission, the frequency offset for the second hop [REF4, TS 38.214] is given in Table 5.

TABLE 5
Frequency offset for second hop of PUSCH transmission
with frequency hopping scheduled by RAR UL grant
or of Msg3 PUSCH retransmission

| Number of physical | | |
|---|---|---|
| resource blocks (PRBs) in | Value of N_{UL, hop} | Frequency offset for |
| initial UL BWP | Hopping Bits | 2^{nd} hop |
| N_{BWP}^{size} < 50 | 0 | └N_{BWP}^{size}/2┘ |
| | 1 | └N_{BWP}^{size}/4┘ |
| N_{BWP}^{size} ≥ 50 | 00 | └N_{BWP}^{size}/2┘ |
| | 01 | └N_{BWP}^{size}/4┘ |
| | 10 | −└N_{BWP}^{size}/4┘ |
| | 11 | Reserved |

A SCS for the PUSCH transmission is provided by subcarrierSpacing in BWP-UplinkCommon. A UE transmits PRACH and the PUSCH on a same uplink carrier of a same serving cell.

A UE transmits a transport block in a PUSCH scheduled by a RAR UL grant in a corresponding RAR message using redundancy version number 0, if the PUSCH transmission is without repetitions. If a temporary cell-radio network temporary identifier (TC-RNTI) is provided by higher layers, the scrambling initialization of the PUSCH corresponding to the RAR UL grant is by TC-RNTI. Otherwise, the scrambling initialization of the PUSCH corresponding to the RAR UL grant is by C-RNTI.

Msg3 PUSCH retransmissions, if any, of the transport block, are scheduled by a DCI format 0_0 with CRC scrambled by a TC-RNTI provided in the corresponding RAR message [REF6, TS 38.321].

With reference to slots for a PUSCH transmission scheduled by a RAR UL grant, if a UE receives a PDSCH with a RAR message ending in slot n for a corresponding PRACH transmission from the UE 116, the UE 116 transmits the PUSCH in slot n+k₂+Δ+2⁴. K_{cell,offset}, where k₂ and Δ are provided in [REF4, TS 38.214] and K_{cell,offset} is provided by cellSpecificKoffset; otherwise, if not provided, K_{cell,offset}=0.

A UE can be provided in BWP-UplinkCommon a set of numbers of repetitions for a PUSCH transmission with PUSCH repetition Type A that is scheduled by a RAR UL grant or by a DCI format 0_0 with CRC scrambled by a TC-RNTI. If the UE 116 requests repetitions for the PUSCH transmission [REF6, TS 38.321], the UE 116 transmits the PUSCH over N_{PUSCH}^{repeat} slots, where N_{PUSCH}^{repeat} is indicated by the 2 MSBs of the MCS field in the RAR UL grant or in the DCI format 0_0 from a set of four values provided by memberOfMsg3-RepetitionsList or from { 1, 2, 3, 4} if mumberOfMsg3-RepetitionsList is not provided. The UE 116 determines an MCS for the PUSCH transmission by the 2 LSBs of the MCS field in the RAR UL grant or by the 3 LSBs of the MCS field in the DCI format 0_0 and determines a redundancy version and RBs for each repetition as described in [REF4, TS 38.214]. For unpaired spectrum operation, the UE 116 determines the N_{PUSCH}^{repeat} slots as the first N_{PUSCH}^{repeat} slots starting from slot n+k₂+Δ where a repetition of the PUSCH transmission does not include a symbol indicated as downlink by tdd-UL-DL-ConfigurationCommon or indicated as a symbol of an SS/PBCH block with index provided by ssb-PositionsInBurst.

The UE 116 may assume a minimum time between the last symbol of a PDSCH reception conveying a RAR message with a RAR UL grant and the first symbol of a corresponding PUSCH transmission scheduled by the RAR UL grant is equal to N_{T,1}+N_{T,2}+0.5 msec, where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 [REF4, TS 38.214] and, for determining the minimum time, the UE 116 evaluates that N₁ and N₂ correspond to the smaller of the SCS configurations for the PDSCH and the PUSCH. For μ=0, the UE 116 assumes N_{1,0}=14 [REF4, TS 38.214].

In response to a PUSCH transmission scheduled by a RAR UL grant when a UE has not been provided a C-RNTI, the UE 116 attempts to detect a DCI format 1_0 with CRC scrambled by a corresponding TC-RNTI scheduling a PDSCH that includes a UE contention resolution identity [11, TS 38.321]. In response to the PDSCH reception with the UE 116 contention resolution identity, the UE 116 transmits hybrid automatic repeat request (HARQ)-acknowledgement (ACK) information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH processing time for UE processing capability 1 when additional PDSCH DM-RS is configured. For μ=0, the UE 116 assumes N_{1,0}=14 [6, TS 38.214].

When detecting a DCI format in response to a PUSCH transmission scheduled by a RAR UL grant, as described in [REF6, TS 38.321], or corresponding PUSCH retransmission scheduled by a DCI format 0_0 with CRC scrambled by a TC-RNTI provided in the corresponding RAR message [REF6, TS 38.321], the UE 116 may assume the PDCCH carrying the DCI format has the same DM-RS antenna port quasi co-location properties, as described in [REF4, TS 38.214], as for a SS/PBCH block the UE 116 used for PRACH association, regardless of whether or not the UE 116 is provided TCI-State for the CORESET where the UE 116 receives the PDCCH with the DCI format.

Throughout the present disclosure, the term “configuration” or “higher layer configuration” and variations thereof (such as “configured” and so on) are used to refer to one or more of: a system information signaling such as by a MIB or a SIB (such as SIB1), a common or cell-specific information provided by dedicated higher layer/RRC signaling, or a dedicated or UE-specific or BWP-specific information provided by dedicated higher layer/RRC signaling.

Throughout the present disclosure, multiple PRACH transmissions refers to multiple repetitions of a same PRACH preamble or to multiple transmissions of more than one PRACH preambles over (one or) multiple time/frequency resources (referred to as RACH occasions or ROs), in a single random access (RA) attempt. For simplicity, the case of a same PRACH preamble is subsequently evaluated. A UE transmitter beam (UE Tx beam) refers to a spatial filter that a UE uses to transmit an UL signal or channel, for example, multiple PRACH transmissions (PRACH repetitions). A UE receiver beam (UE Rx beam) refers to a spatial filter that a UE uses to receive, for example, a DL RS such as an SSB or CSI-RS or a DL channel such as a PDCCH or a PDSCH for RAR.

In various embodiments, a DL/UL RS associated with multiple PRACH transmissions/repetitions can be an SSB or a CSI-RS or an uplink SRS. For example, a UE can transmit the multiple PRACH repetitions with a spatial filter that the UE 116 determines based on quasi co-location properties the UE 116 used to receive the DL RS (such as SSB or CSI-RS) or with a same spatial filter as the one that the UE 116 used to transmit the UL RS (such as SRS). For example, the UE 116 can select the spatial filter based on the UE 116 implementation. For example, the UE 116 transmits the multiple PRACH repetitions with same or different beams (such as narrower beams) than a beam the UE 116 used to receive an SSB. For example, the UE 116 transmits the PRACH repetitions with a spatial filter determined from a CSI-RS reception that is QCLed with an SSB associated with the PRACH. For example, the association of the PRACH transmission with an SSB can be based on transmission of a PRACH repetition in an RO, or using a PRACH preamble, that is associated with the SSB. For example, the UE 116 transmits the number of PRACH repetitions in ROs that are associated with a same SSB, wherein the ROs can be TDMed or FDMed. For example, the UE 116 transmits the number of PRACH repetitions in a single RO using multiple UE Tx beams using for example multiple UE Tx antenna panels. For example, the UE 116 transmits the PRACH in an RO that is associated with the SSB, based on parameters provided by higher layers. The UE 116 can transmit first repetitions, from a number of repetitions, using a first beam, and transmit second repetitions, from the number of repetitions, using a second beam. For example, both the first and second beams are determined based on QCL properties of an associated SSB. For example, the UE 116 can transmit first PRACH repetitions in first ROs or using first PRACH preambles, and can transmit second PRACH repetitions in second ROs or using second PRACH preambles. For example, the information of the first and second ROs, or the first and second PRACH preambles, can be provided by system information or by UE-dedicated higher layer information. In one example, selection of the first and second ROs, or the first and second PRACH preambles, can be based on UE implementation.

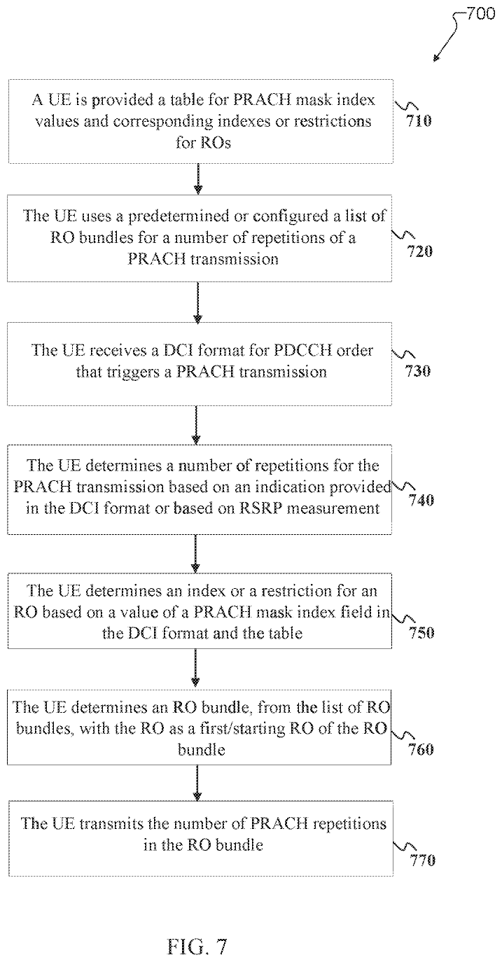

FIG. 7 illustrates a flowchart of an example UE procedure 700 for transmitting a number of PRACH repetitions according to embodiments of the present disclosure. For example, UE procedure 700 for transmitting a number of PRACH repetitions can be performed by the UE 116 of FIG. 3. This example is for illustration only and other embodiments can be used without departing from the scope of the present disclosure.

The procedure begins in 710, a UE is provided a table for PRACH mask index values and corresponding indexes or restrictions for ROs. In 720, the UE 116 uses a predetermined or configured a list of RO bundles for a number of repetitions of a PRACH transmission. In 730, the UE 116 receives a DCI format for PDCCH order that triggers a PRACH transmission. In 740, the UE 116 determines to a number of repetitions for the PRACH transmission based on an indication provided in the DCI format or based on RSRP measurement. In 750, the UE 116 determines an index or a restriction for an RO based on a value of a PRACH mask index field in the DCI format and the table. In 760, the UE 116 determines an RO bundle, from the list of RO bundles, with the RO as a first/starting RO of the RO bundle. In 770, the UE 116 transmits the number of PRACH repetitions in the RO bundle.

In various embodiments, the term “RO bundle” is used to refer to a set of ROs that a UE uses for one RA attempt with multiple PRACH transmissions/repetitions. For example, an RO bundle can be predetermined in the specifications of system operation or can be provided by higher layer configuration. For example, higher layers can provide a list of L RO bundles wherein each RO bundle includes N RO indexes. (For example, individual ROs can be indexed per predetermined rules, such as those described in [REF3, TS 38.213, v17.4.0] where the indexing is first in ascending order of frequency and second in ascending order of time with a potential reset per association pattern period). For example, an RO bundle can be determined by the UE 116 based on predetermined or (pre)configured rules, such as an association with a same SSB or CSI-RS and having TDM ROs. For example, different predetermined or (pre)configured RO bundles can be of a same size (to support only one value for a number of PRACH repetitions, or based on a largest value of supported numbers of PRACH repetitions), or can have different sizes corresponding, for example, to different numbers of repetitions.

In various embodiments, the term “PRACH preamble bundle” is used to refer to a set of PRACH preambles that a UE uses for one RA attempt with multiple PRACH transmissions/repetitions. For example, a PRACH preamble bundle can be predetermined in the specifications of system operation or can be provided by higher layer configuration. For example, higher layers can provide a list of L PRACH preamble bundles wherein each bundle includes N PRACH preamble indexes. For example, a PRACH preamble bundle can be determined by the UE 116 based on predetermined or (pre)configured rules, such as having consecutive PRACH preamble indexes. For example, different predetermined or (pre)configured PRACH preamble bundles can be of a same size (to support only one value for a number of PRACH repetitions, or based on a largest value of supported numbers of PRACH repetitions), or can have different sizes corresponding, for example, to different numbers of repetitions.

In one example, a PDCCH order can include an indication of a number of PRACH repetitions. For example, a mapping among values of a field in a PDCCH order and a set of values for a number of PRACH repetitions can be defined in the specifications of the system operation or by higher layer configuration such as SIB1 or common or dedicated RRC signaling. For example, when a UE is provided up to 4 values for a number of PRACH repetitions, the PDCCH order can include a 2-bit field to indicate one of the 4 values. For example, a ‘00’, ‘01’, ‘10’ or ‘11’ value in the corresponding field of PDCCH order indicates a respective first, second, third, or fourth value for a number of PRACH repetitions. For example, one of the four values can correspond to a value 1, that is, no/one repetition. For example, the field is present at least when the UE 116 is configured multiple values for a number of PRACH repetitions. For example, when the UE 116 is predetermined or configured only one value for the number of PRACH repetitions, in one option, the field is not present (0 bits) and the UE 116 transmits any PRACH triggered by PDCCH order with a number of repetitions that is equal to the one predetermined/configured value. In another option, the DCI format providing the PDCCH order includes 1 bit to indicate no repetition (that is, one PRACH transmission/repetition) or to indicate multiple PRACH transmissions with the predetermined/configured value (e.g., 4 repetitions). In one example, a PDCCH order can indicate an intermediate parameter, such as a coverage enhancement (CE) level, and the UE 116 can determine a number of PRACH repetitions based on a predetermined or higher layer mapping between the CE levels and the numbers of repetitions. For example, the CE levels can be mapped to other configuration parameters for PRACH transmission, such as one or more of PRACH preambles, ROs, and SSBs.

In another example, a number of repetitions is not indicated by the DCI format providing the PDCCH order (even when a UE is configured multiple values for a number of PRACH repetitions) and the UE 116 determines the number of repetitions based on RSRP measurement and a comparison of the measured RSRP to an RSRP threshold that is indicated by higher layers, such as a SIB or UE-specific RRC. For example, the UE 116 determines a number of repetitions and the gNB 102 transmits the PDCCH order without knowledge of the UE 116 determination for the number of repetitions. For example, there is no new field or no modification to fields of a DCI format for PDCCH order, for example as described in [REF2, TS 38.212, v17.3.0]. For example, when the UE 116 determines a number of PRACH repetitions based on RSRP measurements, the UE 116 determines information related to PRACH repetitions, such as for the ROs or PRACH preambles or the associated DL RSs, by re-interpreting the values provided in the PDCCH order as subsequently described. In one example, such re-interpretation may continue to apply also when the PDCCH order indicates PRACH transmissions with repetitions using an explicit field that indicates the number of repetitions or an RSRP range associated with a number of repetitions for a PRACH transmission or based on higher layer configuration.

In one embodiment, for a PRACH transmission triggered by a PDCCH order, a UE can determine, based on DL RS measurements or based on a gNB indication, a number of repetitions for the PRACH transmission. An existing “mask index” field in a DCI format for the PDCCH order, such as DCI format 1_0, can be reinterpreted or new/additional “mask index” fields can be included to indicate information for an RO bundle to be used by the UE 116 for the number of repetitions of the PRACH transmission. Such a method can be applicable to, for example, a UE with an established RRC connection.

For the UE 116 behavior for interpreting the mask index field in the PDCCH order, when PRACH is with multiple transmissions/repetitions, the following approaches can be evaluated.

In a first approach, when a PDCCH order indicates multiple repetitions for a PRACH transmission (with same or different preambles), or when the UE 116 determines a number of repetitions for transmitting a PRACH triggered by PDCCH order, the UE 116 can determine an RO bundle for the number of repetitions of the PRACH transmission based on the mask index field. Additionally, some re-interpretations of the mask index field may also apply. For example, the mask index field of the DCI format providing the PDCCH order can include information for an associated RO bundle, for example, by indicating one or more of: a first/starting RO from the RO bundle, a value that jointly encodes a first/starting RO from the RO bundle together with the FH pattern of the RO bundle, or an index or restriction for the RO bundle.

In a first option, a PDCCH order includes one mask index that indicates one of the values from the Table 7.4-1 of [REF6, TS 38.321, v17.3.0], for example, an indication for RO index 1, RO index 2, and so on. The value of the mask index field provides an index or a restriction for a first/starting RO from the RO bundle. In one example, the UE 116 determines the remaining ROs of the RO bundle for PRACH repetition, for example, based on predetermined rules in the specifications of the system operation or based on (pre-)configured rules provided by higher layers. For example, the rule can be to select remaining ROs of the RO bundle:
to be associated with a same SSB as a first/starting RO having an index or restriction provided by the PDCCH order; or
to be associated with a same PRACH preamble; or
to be TDM, i.e., in different slots/PRACH slots; or
to have a smallest possible time gap (such as consecutive slots/PRACH slots, or minimum number of gaps slots).

In another example, a UE determines remaining ROs of an RO bundle by selecting an RO bundle from a set of configured RO bundles such that a first/starting RO of the selected RO bundle is an RO based on the index or restriction indicated by the mask index field of the PDCCH order.

For example, the UE 116 can determine a unique RO bundle (based on the specification rules or based on an indication by higher layers) with a starting RO indicated by the PDCCH order. In another example, the UE 116 can determine a number of RO bundles (based on specification rules or based on an indication by higher layers) with the starting RO indicated by the PDCCH order. In the latter case, an RO bundle selection for repetitions of a PRACH transmission is up to UE implementation.

In a second option, a value of a mask index field in the DCI format for PDCCH order provides a value for a single parameter that jointly encodes a first/starting RO of the RO bundle and a FH pattern for the RO bundle. Such an indication method can be beneficial, for example, when the UE 116 is configured FDMed ROs in a same slot or RACH slot or symbol so that more than one RO combinations are possible to form an RO bundle in a given pair or tuple of time slots/RACH slots/symbols.

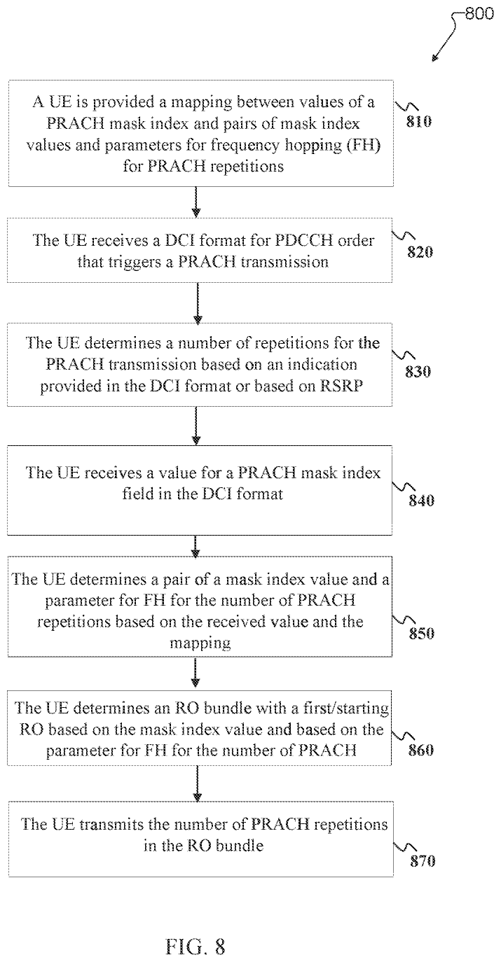

FIG. 8 illustrates a flowchart of an example UE procedure 800 for transmitting a number of PRACH repetitions according to embodiments of the present disclosure. For example, procedure 800 for transmitting a number of PRACH repetitions may be performed by the UE 115 of FIG. 1. This example is for illustration only and other embodiments can be used without departing from the scope of the present disclosure.

The procedure begins in 810, a UE is provided a mapping between values of a PRACH mask index and pairs of mask index values and parameters for frequency hopping (FH) for PRACH repetitions. In 820, the UE 116 receives a DCI format for PDCCH order that triggers a PRACH transmission. In 830, the UE 116 determines a number of repetitions for the PRACH transmission based on an indication provided in the DCI format or based on RSRP measurement. In 840, the UE 116 receives a value for a PRACH mask index field in the DCI format. In 850, the UE 116 determines a pair of a mask index value and a parameter for FH for the number of PRACH repetitions based on the received value and the mapping. In 860, the UE 116 determines an RO bundle with a first/starting RO based on the mask index value and based on the parameter for FH for the number of PRACH repetitions. In 870, the UE 116 transmits the number of PRACH repetitions in the RO bundle.

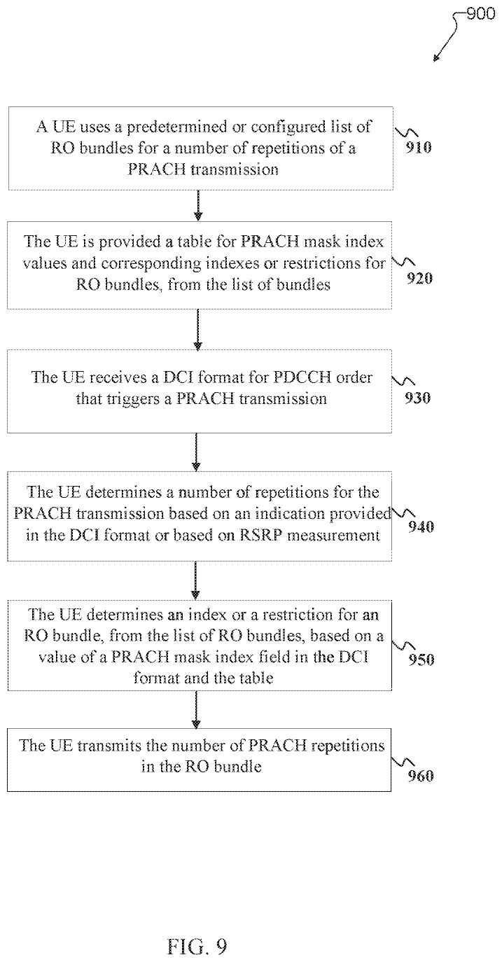

FIG. 9 illustrates a flowchart of an example UE procedure 900 for transmitting a number of PRACH repetitions according to embodiments of the present disclosure. For example, procedure 900 for transmitting a number of PRACH repetitions can be performed by any of the UEs 111-116 of FIG. 1. This example is for illustration only and other embodiments can be used without departing from the scope of the present disclosure.

The procedure begins in 910, a UE uses a predetermined or configured list of RO bundles for a number of repetitions of a PRACH transmission. In 920, the UE 116 is provided a table for PRACH mask index values and corresponding indexes or restrictions for RO bundles, from the list of bundles. In 930, the UE 116 receives a DCI format for PDCCH order that triggers a PRACH transmission. In 940, the UE 116 determines a number of repetitions for the PRACH transmission based on an indication provided in the DCI format or based on RSRP measurement. In 950, the UE 116 determines an index or a restriction for an RO bundle, from the list of RO bundles, based on a value of a PRACH mask index field in the DCI format and the table. In 960, the UE 116 transmits the number of PRACH repetitions in the RO bundle.

For example, the UE 116 can be provided a new table for the mask index field or some of the reserved values from the Table 7.4-1 of [REF6, TS 38.321, v17.3.0] can include a number of combinations (for example, up to 16 combinations), where each combination is a pair of:
an index or a restriction for a first/starting RO of the RO bundle, and/or
an index or value for a frequency hopping (FH) pattern, from a number of predetermined or configured indexes for FH.

Accordingly, a value of the mask index field provides an index for a combination from the number of combinations.

For example, an index FH=0 can correspond to no frequency hopping, and an index FH=1 can correspond to frequency hopping with a predetermined or configured FH offset value, such as an offset value equal to 2 FDMed ROs in a next PRACH repetition, and continuing the same FH pattern. When multiple values are configured for FH for PRACH repetition, additional indexes such as FH=2 or FH=3 can be also used to indicate other values/patterns for FH.

When the UE 116 finds multiple RO bundles that satisfy the combination indicated by the joint-coded value in the mask index field of the PDCCH order, it is up to UE implementation to select an RO bundle from the multiple RO bundles.

In a third option, the mask index field in the PDCCH order is interpreted to provide an index or restriction for the entire RO bundle.

For example, values 0-10 for the mask index field are retained for indication of a single RO as per [REF6, TS 38.321, v17.3.0] reproduced in the present disclosure as Table 0 (such as for a PRACH transmission with a single repetition, or for a first/starting RO of an RO bundle for a PRACH transmission with multiple repetitions triggered by higher layers), while some values from values 11-15 (that are reserved in [REF6, TS 38.321, v17.3.0]) are used to indicate indexes or restrictions for RO bundles, such as all RO bundles, RO bundle index 1, 2, 3, and so on, or odd/even RO bundle indexes, and so on. In another example, all values of the PRACH mask index from Table 7.4-1 in [REF6, TS 38.321, v17.3.0] can be used to indicate RO bundles. For example, the UE can interpret both existing values 0-10 and/or (some of) reserved values 11-15 to indicate RO bundles when the RA procedure is with PRACH repetition, such as when the PDCCH order indicates a number of repetitions more than one, or when the UE determines more than one PRACH repetition based on measurements such as SSB or CSI-RS RSRP measurements. In another example, additional values/rows can be added to Table 7.4-1 in [REF6, TS 38.321, v17.3.0] to support indication of RO bundles.

For example, RO bundles can be indexed in a number of ways, such as:
in ascending order of a reference RO in the RO bundle, such as a first/starting RO or a last/ending RO, from the RO bundle;
   Ordering of individual ROs can be based on predetermined rules in the specifications of the system operation, such as [REF3, TS 38.213, v17.4.0], for example frequency first, and time second.
   For examples, additional time separation, e.g., based on higher layer parameter TimeOffsetBetweenStartingRO, can be applied between first/starting ROs of different RO bundles, such as two RO bundles with consecutive RO bundle indexes, such that ordering of RO bundles is also based on such additional time separation.
   For example, the UE 116 does not expect a PRACH configuration that leads to multiple RO bundles with a same reference RO.
   For example, the UE 116 may determine multiple RO bundles with a same reference RO, and the UE 116 assigns a same index to the multiple RO bundles. In this case, for example, when the UE 116 is provided the index in a PRACH mask index field/parameter, the UE 116 can select any of the multiple RO bundles.
based on predetermined or configured rules for ordering RO bundles, such as:
   in ascending order of a first/starting RO from the RO bundle and, when multiple RO bundles share a same first/starting RO, in ascending order of a frequency hopping (FH) index. For example, a FH index can refer to an index for a FH offset parameter value such as no FH as index 0, and FH with a first offset value as FH index 1, and so on; or
   in ascending order of a first/starting RO from the RO bundle and, when multiple RO bundles share a same first/starting RO, in ascending order of a second/next RO from the RO bundle, and so on; and/or
based on an explicit index provided for an RO bundle, such as when the UE 116 is provided a list of RO bundles together with corresponding indexes for the RO bundles.

For example, the UE can determine an index for an RO bundle

this is equivalent to having a time separation between ROs in a group of ROs . . . ” or whatever is applicable based on the DOI. I also don't see a difference between Claim 4 and Claim 7. Claim 4 is generic enough to also be applicable if there is TimeOffsetBetweenStartingRO

For example, an indexing of RO bundles can be reset per PRACH association pattern period or per a number of PRACH association pattern period, wherein the number can be predetermined or configurable, or can be determined based on predetermined rules, such as rules for association of RO bundles to SSBs.

In another example, the specifications of the system operation can include a new table (for example, with 16 rows), separate from Table 7.4-1 in [REF6, TS 38.321, v17.3.0], to provide mask index values corresponding to RO bundles for a PRACH transmission with multiple repetitions.

In a second approach, when a PDCCH order indicates a PRACH transmission with a number of repetitions, or when the UE 116 determines to transmit a PRACH triggered by PDCCH order using a number of repetitions, the UE 116 can determine an RO bundle for the number of PRACH repetitions based on new field in the DCI format for PDCCH order, in addition to the mask index field. For example, the PDCCH order can include:
one mask index field for each RO of the RO bundle (for example, N mask index fields for PRACH with N repetitions); and/or
a field for FH information, separate from the existing field for PRACH mask index. For example, a DCI format for PDCCH order can include a field to indicate whether frequency hopping is enabled or disabled, or to indicate information of one or more of the frequency hopping parameters. For example, the DCI format for PDCCH order can include a field with 2 bits that indicates one of 4 configured values for a frequency offset. For example, the DCI format for PDCCH order can include a field with 2 bits that indicates one of 4 configured values for a starting RB index for a first hop/PRACH repetition. For example, a value from 4 configured values can be reserved or can equivalently point to a same frequency allocation for all PRACH repetitions (i.e., no FH operation).

In one embodiment, for a number of repetitions of a PRACH transmission triggered by a PDCCH order, an existing “PRACH preamble index” field in the DCI format for PDCCH order, such as a DCI format 1_0, can indicate to the UE 116 to use a same PRACH preamble for the number of repetitions of the PRACH transmission, or the “PRACH preamble index” field can be reinterpreted or new/additional “PRACH preamble index” fields can be included in the PDCCH order to indicate information for a set/bundle of PRACH preambles for the UE 116 to use for the number of repetitions for the PRACH transmission.

For example, when a UE receives a DCI format for PDCCH order and determines to transmit the PRACH with a number of repetitions/transmissions (based on an indication by the PDCCH order or based on a determination, based for example on RSRP measurements, by the UE 116), a “PRACH preamble index” field in the DCI format indicates:
an index of a PRACH preamble for a first/starting PRACH repetition, and the UE 116 uses a same PRACH preamble for remaining PRACH repetitions from the number of PRACH repetitions; or
an index of a PRACH preamble for a first/starting PRACH repetition, and the UE 116 determines indexes for PRACH preambles for remaining PRACH repetitions from the number of PRACH repetitions based on a predetermined/configured rule, such as consecutive PRACH preamble indexes, or based on a predetermined/(pre)configured offset value, as subsequently described; or
an index of a PRACH preamble bundle, from a set of predetermined or configured PRACH preambles, wherein a PRACH preamble bundle includes multiple PRACH preambles that the UE 116 uses to transmit the number of PRACH repetitions. For example, the UE 116 can be provided a table that jointly encodes the indexes of the multiple PRACH preambles in the PRACH preamble bundle, using for example up to 64 rows. Accordingly, the “PRACH preamble index” field the DCI format for PDCCH order can indicate a row index from the table.

The “PRACH preamble index” can include 6 bits as in [REF2, TS 38.212, v17.4.0] or can be extended, e.g., to 7 bits.

For example, a PRACH preamble bundle can include PRACH preambles with a configured offset value, such as an offset value of 2 (that is, every other PRACH preamble), or an offset value of 4 (that is, every fourth PRACH preamble), starting from a first PRACH preamble.

For example, the offset value can be an offset with respect to an index of a first PRACH preamble corresponding to a first/starting PRACH repetition or an index of an immediately previous PRACH preamble corresponding to an immediately previous PRACH repetition. For example, the offset value can be with respect to an index of a first/starting PRACH preamble associated with an RO where the UE 116 transmits a corresponding first PRACH repetition. For example, when first and second ROs corresponding to first/starting and second/next PRACH repetitions are associated with PRACH preamble indexes {4, 5, 6, 7} and {24, 25, 26, 27}, respectively, an offset value of 2 indicates that the UE 116 transmits the first PRACH repetition using PRACH preamble with index 4+2=6 and transmits the second PRACH repetition using PRACH preamble with index 24+2=26. According to this example, the UE 116 can be provided only an offset value without information of an index for a first/starting PRACH preamble corresponding to the first PRACH repetition.

For example, the index of the first PRACH preamble index can be provided by the PDCCH order and the offset value can be provided by higher layers or by the PDCCH order (for example, using a separate field with 1 or 2 bits for the offset value). In another example, a value of the PRACH preamble index and an offset value can be jointly coded using a table provided by higher layers. Accordingly, a parameter in a DCI format for PDCCH order can include a field (such as 6 or 7 bits) that provides a row index to the table so that the UE 116 can determine both the first PRACH preamble index and the offset value.

For example, the DCI format for PDCCH order can include a number of new/additional fields for “PRACH preamble index” that provide indexes for the PRACH preambles for the UE 116 to use for a number of repetitions of the PRACH transmission, such as N “PRACH preamble index” fields for N repetitions of the PRACH transmission.

For example, a UE can separately determine PRACH preambles corresponding to a number of repetitions for a PRACH transmission based on the UE 116 implementation for each PRACH repetition based on the procedures described in [REF3, TS 38.213, v17.4.0] and [REF6, TS 38.321, v17.3.0].

In one embodiment, a PDCCH order can indicate a number of repetitions for a PRACH transmission that are associated with a number of two or more DL RSs, such as two SSBs. A field for a SSB index in the DCI format for PDCCH order can be re-interpreted/modified, or new fields can be included, to provide information for the number of DL RSs or information for an association pattern for of the number of DL RSs with the number of repetitions for the PRACH transmission.

In one example, a PDCCH order can indicate that a number of repetitions for a PRACH transmission correspond to a number of DL RSs, such as two SSBs or two CSI-RSs. For example, the UE 116 can be provided by a PDCCH order information for a number of DL RSs, such as for two SSB indexes or for two CSI-RS resource IDs. For example, for two DL RSs, two indexes for the two DL RSs can be provided separately or a first index for the first DL RS can be provided together with an offset to determine an index for the second DL RS. For example, for two DL RSs, a single DCI field in the PDCCH order jointly encodes two indexes for the two DL RSs. For example, the UE 116 is provided a list of sets of DL RSs, such as a list of SSB pairs, and the “SSB index” field in the PDCCH order provides an index for a set of DL RSs, such as a pair of SSBs from the list of sets.

For example, the PDCCH order can include a field that indicates whether one DL RS or a predetermined or configured number of DL RSs, such as two DL RSs, are provided. For example, when the PDCCH order includes only one field or value for an SSB index or for a CSI-RS resource index, or when the PDCCH order includes two fields or two values providing a same SSB index or CSI-RS resource index, the UE 116 determines to transmit the PRACH in association with only one DL RS or UE Tx beam/spatial filter.

When a PDCCH order indicates a number of repetitions for a PRACH transmission that correspond to a number of DL RSs, such as two DL RSs, in one example, a number of PRACH repetitions for each of the DL RSs or across the DL RSs can be indicated by a field in the PDCCH order. For example, for two DL RSs, the two values for the numbers of repetitions corresponding to the two DL RSs are separately provided by the PDCCH order. For example, a single value in a single field for the number of repetitions jointly encodes the values for the numbers of repetitions corresponding to the number of DL RSs. For example, the UE 116 is provided a list of sets of values for the numbers of repetitions for the sets of DL RSs and the PDCCH order provides an index for a set from the list of sets. For example, PDCCH order provides only a single value for a number of repetitions that indicates a single value for a number of repetitions and the UE 116 transmits the number of repetitions using each spatial filter associated with each DL RS from the set of DL RSs.

In another example, the PDCCH order does not indicate a number of repetitions for a PRACH transmission and the UE 116 determines the number of repetitions for the sets of DL RSs (separately or jointly) based on UE measurements from the set of indicated DL RSs, such as SS-RSRPs, and comparison with corresponding thresholds or RSRP ranges. For example, the set of DL RSs can include two DL RSs such as two SSBs.

In one example, the UE 116 determines whether the DCI format for PDCCH order can indicate one DL RS or a set of DL RSs, such as two DL RSs, based on an indication by higher layers. In another example, the DCI format for PDCCH order can include a field that indicates whether the repetitions of a PRACH transmission triggered by the PDCCH order are associated with one DL RS or with a set of DL RSs, such as two DL RSs.

In one example, the DCI format for PDCCH order can include a field with values of ‘0’ and ‘1’ that respectively indicate whether repetitions of a PRACH transmission are associated with first and second DL RSs (that is, in ascending order of indexes of DL RSs), or whether the repetitions of the PRACH transmissions are associated with second and first DL RSs (that is, in descending order of indexes of DL RSs).

In one example, the DCI format for PDCCH order can include a field that indicates both whether PRACH repetitions are with respect to one or a set of DL RSs, such as two DL RS, and also the order of DL RS application to the PRACH repetition. For example, value ‘00’ can indicate that only one DL RS is applicable (whose index is provided in a separate field) while values ‘01’ and ‘10’ can respectively indicate that PRACH repetitions are associated with first and second DL RSs (that is, ascending order of DL RSs) and PRACH repetitions are associated with the second and first DL RSs (that is, descending order of DL RSs), or vice versa. The information of the first and second DL RSs are provided by separate fields. For example, a value ‘11’ can be reserved.

In another example, PRACH repetitions can be associated with more than two DL RSs. For example, PRACH repetitions can be associated with three DL RSs, whose indexes are provided to the UE 116 by higher layers or by the PDCCH order as described herein. For simplicity, herein, they are referred to as DL RS {1, 2, 3}. Then, the DCI format for PDCCH order can include a field, such as with 2 bits, that indicates one or multiple DL RSs associated with the PRACH repetitions. For example, a value ‘00’ can indicate one DL RS from the DL RSs {1, 2, 3}, a value ‘01’ can indicate DL RSs {1, 2}, a value ‘10’ can indicate DL RSs {1, 3}, and value ‘11’ can indicate DL RSs {2, 3}. For example, for value ‘00’, the PDCCH order can indicate which DL RS from the DL RSs {1, 2, 3} are used for PRACH association or a predetermined rule can be used, such as a DL with the smallest/largest DL RS index.

For example, association of PRACH repetitions with a set of DL RSs can be in terms of groups of repetition with size Ng, wherein a first number of Ng repetitions are associated with the first DL RS, a second Ng number of repetitions are associated with the second DL RS, and so on. Such setting with Ng=1 or Ng=2 can be respectively referred to as cyclic and sequential beam pattern.

Information of cyclic pattern or a sequential pattern for alternating among DL RSs from a set of DL RSs (for example, size of each repetition group, that is, a number of repetitions for each DL RS such as Ng=1 or Ng=2 before switching to another DL RS) can be provided by:
higher layers, or
a field in the PDCCH order that is separate from a field for DL RS selection and ordering, or
a field in the PDCCH order that jointly encodes the repetition pattern information with the aforementioned information for DL RS selection and ordering.

Such methods for cyclic or sequential pattern of PRACH repetitions, with parameters provided by higher layers, can be also applicable to PRACH repetition triggered by higher layers.

The methods described herein can apply when UE Tx beams are used instead of DL RS.

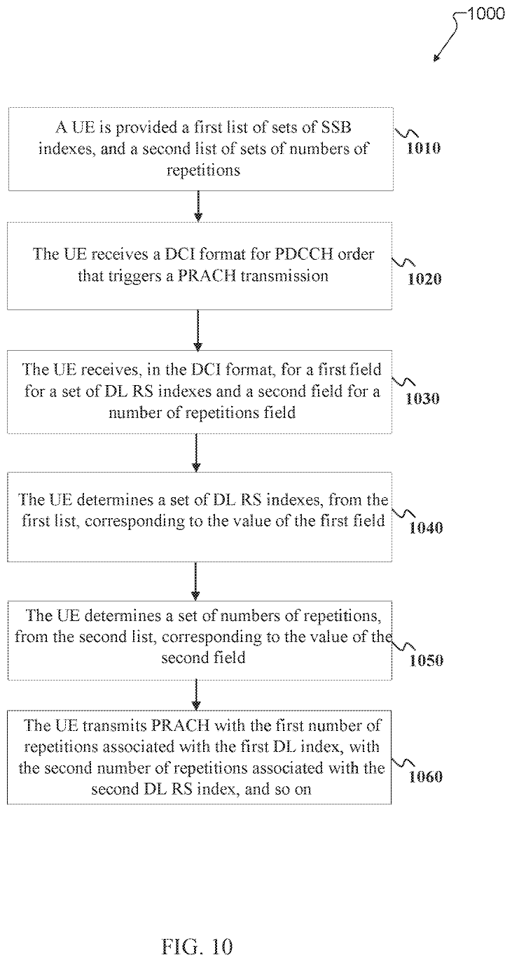

FIG. 10 illustrates a flowchart of an example UE procedure 1000 for transmitting PRACH according to embodiments of the present disclosure. For example, procedure 1000 for transmitting PRACH can be performed by the UE 114 of FIG. 1. This example is for illustration only and other embodiments can be used without departing from the scope of the present disclosure.

The procedure begins in 1010, a UE is provided a first list of sets of DL RS indexes, such as SSB indexes or CSI-RS resource indexes, and a second list of sets of numbers of repetitions for a PRACH transmission. In 1020, the UE 116 receives a DCI format for PDCCH order that triggers a PRACH transmission. In 1030, the UE 116 receives, in the DCI format, a first value for a DL RS index field and a second value for a number of repetitions field. In 1040, the UE 116 determines a set of DL RS indexes, such as a pair of first and second SSB indexes, from the first list corresponding to the first value. In 1050, the UE 116 determines a set of number of repetitions, such as first and second numbers of repetitions, from the second list corresponding to the second value. In 1060, the UE 116 transmits PRACH with the first number of repetitions associated with the first DL RS index, with the second number of repetitions associated with the second DL RS index, and so on.

The present disclosure can be applicable to NR specifications Rel-18 and beyond to support PDCCH order for multiple PRACH transmissions/repetitions.

The embodiments are generic and can also apply to various frequency bands in different frequency ranges (FR) such as FR1, FR2, FR3, and FR2-2, e.g., low frequency bands such as below 1 GHz, mid frequency bands, such as 1-7 GHz, or 7-24 GHz, and high/millimeter frequency bands, such as 24-100 GHz and beyond. In addition, the embodiments are generic and can apply to various use cases and settings as well, such as single-panel UEs and multi-panel UEs, eMBB, URLLC and IIoT, mMTC and IoT including NB-IoT, NR IoT, and Ambient IoT (A-IoT), sidelink/vehicle-to-everything (V2X), operation with multi-TRP/beam/panel, operation in unlicensed/shared spectrum (NR-U), non-terrestrial networks (NTN), aerial systems such as drones, operation with reduced capability (RedCap) UEs, private or non-public networks (NPN), and so on.

The present disclosure relates to a pre-5th-Generation (5G) or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

Embodiments of the disclosure are directed to the NR standard.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for transmission of a physical random access channel (PRACH) preamble, the method comprising:
identifying:
a set of numbers of repetitions for the PRACH preamble transmission, and
a first mapping among values of a PRACH mask index and a set of groups of PRACH occasions;
receiving a downlink control information (DCI) format for a physical downlink control channel (PDCCH) order that indicates:
a first value for a PRACH preamble index,
a second value for a synchronization signal and physical broadcast channel (SS/PBCH) block index, and
a third value for the PRACH mask index;
determining:
a number of repetitions from the set of numbers of repetitions, and
based on the third value and the first mapping, a group of PRACH occasions from the set of groups of PRACH occasions; and
transmitting the PRACH preamble having the PRACH preamble index with the number of repetitions over the group of PRACH occasions.

2. The method of claim 1, wherein the number of repetitions is determined based on a value of a field in the DCI format.

3. The method of claim 1, further comprising:
receiving:
information of a second mapping among a set of reference signal received power (RSRP) ranges and the set of numbers of repetitions, and
SS/PBCH blocks with the SS/PBCH block index; and
determining:
an RSRP based on the SS/PBCH blocks,
an RSRP range, from the set of RSRP ranges, that includes the RSRP, and
the number of repetitions based on the RSRP range and the second mapping.

4. The method of claim 1, further comprising:
determining a starting PRACH occasion for the group of PRACH occasions based on the third value of the PRACH mask index and the first mapping; and
determining remaining PRACH occasions for the group of PRACH occasions based on the starting PRACH occasion, wherein:
the first mapping is among values of the PRACH mask index and indexes of starting PRACH occasions for groups of PRACH occasions,
the third value of the PRACH mask index maps to first indexes of first starting PRACH occasions for first groups of PRACH occasions, and
the group of PRACH occasions is selected among the first groups of PRACH occasions.

5. The method of claim 4, wherein PRACH occasions are indexed in ascending order, first in a frequency domain and second in a time domain.

6. The method of claim 1, wherein:
the first mapping is among values of the PRACH mask index and indexes of groups of PRACH occasions, and
the group of PRACH occasions has an index that maps to the third value of the PRACH mask index based on the first mapping.

7. The method of claim 1, wherein the group of PRACH occasions:
include a number of consecutive PRACH occasions that is same as the number of repetitions for the PRACH preamble transmission,
has same frequency domain resources, and
is associated with the SS/PBCH block index and the PRACH preamble index.

8. A user equipment (UE) comprising:
a processor configured to identify:
a set of numbers of repetitions for a transmission of a physical random access channel (PRACH) preamble, and
a first mapping among values of a PRACH mask index and a set of groups of PRACH occasions; and
a transceiver operably coupled to the processor, the transceiver configured to receive a downlink control information (DCI) format for a physical downlink control channel (PDCCH) order that indicates:
a first value for a PRACH preamble index,
a second value for a synchronization signal and physical broadcast channel (SS/PBCH) block index, and
a third value for the PRACH mask index,
wherein the processor is further configured to determine:
a number of repetitions, from the set of numbers of repetitions, for the PRACH preamble transmission, and
based on the third value and the first mapping, a group of PRACH occasions from the set of groups of PRACH occasions, and
wherein the transceiver is further configured to transmit the PRACH preamble having the PRACH preamble index with the number of repetitions over the group of PRACH occasions.

9. The UE of claim 8, wherein the number of repetitions is determined based on a value of a field in the DCI format.

10. The UE of claim 8, wherein:
the transceiver is further configured to receive:
information of a second mapping among a set of reference signal received power (RSRP) ranges and the set of numbers of repetitions, and
SS/PBCH blocks with the SS/PBCH block index; and
the processor is further configured to determine:
an RSRP based on the SS/PBCH blocks,
an RSRP range, from the set of RSRP ranges, that includes the RSRP, and
the number of repetitions based on the RSRP range and the second mapping.

11. The UE of claim 8, wherein:
the processor is further configured to determine:
a starting PRACH occasion for the group of PRACH occasions based on the third value of the PRACH mask index and the first mapping, and
remaining PRACH occasions for the group of PRACH occasions based on the starting PRACH occasion,
the first mapping is among values of the PRACH mask index and indexes of starting PRACH occasions for groups of PRACH occasions,
the third value of the PRACH mask index maps to first indexes of first starting PRACH occasions for first groups of PRACH occasions, and
the group of PRACH occasions is selected among the first groups of PRACH occasions.

12. The UE of claim 11, wherein PRACH occasions are indexed in ascending order, first in a frequency domain and second in a time domain.

13. The UE of claim 8, wherein:
the first mapping is among values of the PRACH mask index and indexes of groups of PRACH occasions, and
the group of PRACH occasions has an index that maps to the third value of the PRACH mask index based on the first mapping.

14. The UE of claim 8, wherein the group of PRACH occasions:
include a number of consecutive PRACH occasions that is same as the number of repetitions for the PRACH preamble transmission,
has same frequency domain resources, and
is associated with the SS/PBCH block index and the PRACH preamble index.

15. A base station comprising:
a processor configured to identify:
a set of numbers of repetitions for a reception of a physical random access channel (PRACH) preamble, and
a first mapping among values of a PRACH mask index and a set of groups of PRACH occasions; and
a transceiver operably coupled to the processor, the transceiver configured to transmit a downlink control information (DCI) format for a physical downlink control channel (PDCCH) order that indicates:
a first value for a PRACH preamble index,
a second value for a synchronization signal and physical broadcast channel (SS/PBCH) block index, and
a third value for the PRACH mask index,
wherein the processor is further configured to determine:
a number of repetitions, from the set of numbers of repetitions, for the PRACH preamble reception, and
based on the third value and the first mapping, a group of PRACH occasions from the set of groups of PRACH occasions,
wherein the transceiver is further configured to receive the PRACH preamble having the PRACH preamble index with the number of repetitions over the group of PRACH occasions.

16. The base station of claim 15, wherein the number of repetitions is determined based on a value of a field in the DCI format.

17. The base station of claim 15, wherein:
the processor is further configured to determine:
a starting PRACH occasion for the group of PRACH occasions based on the third value of the PRACH mask index and the first mapping, and
remaining PRACH occasions for the group of PRACH occasions based on the starting PRACH occasion,
the first mapping is among values of the PRACH mask index and indexes of starting PRACH occasions for groups of PRACH occasions,
the third value of the PRACH mask index maps to first indexes of first starting PRACH occasions for first groups of PRACH occasions, and
the group of PRACH occasions is among the first groups of PRACH occasions.

18. The base station of claim 17, wherein PRACH occasions are indexed in ascending order, first in a frequency domain and second in a time domain.

19. The base station of claim 17, wherein:
the first mapping is among values of the PRACH mask index and indexes of groups of PRACH occasions, and
the group of PRACH occasions has an index that maps to the third value of the PRACH mask index based on the first mapping.

20. The base station of claim 15, wherein the group of PRACH occasions:
include a number of consecutive PRACH occasions that is same as the number of repetitions for the PRACH preamble reception,
has same frequency domain resources, and
is associated with the SS/PBCH block index and the PRACH preamble index.
